(19) United States
(12) Patent Application Publication
(10) Pub. No.: US 2011/0266275 A1
(43) Pub. Date: Nov. 3, 2011

(54) TRANSPARENT OBJECT WITH A LOCALLY LIMITED, STRUCTURED, ELECTRICALLY HEATABLE, TRANSPARENT AREA, METHOD FOR MANUFACTURE THEREOF AND USE THEREOF

(76) Inventor: Mitja Rateiczak, Wurselen (DE)

(21) Appl. No.: 13/119,176

(22) PCT Filed: Oct. 13, 2009
(86) PCT No.: PCT/EP2009/063309

§ 371 Date: May 23, 2011

(30) Foreign Application Priority Data
Oct. 15, 2008 (DE) 10 2008 051 730.5

(51) Int. Cl. H05B 3/02; B05D 3/12; B05D 3/02; B05D 5/12; B05D 3/06

(52) U.S. Cl. 219/538; 427/58; 427/532

(57) ABSTRACT

A transparent object comprising a transparent, electrically insulating substrate with an electrically conducting transparent coating is described. The transparent coating comprises at least one localized, structured, electrically heatable, transparent area. Methods to manufacture such transparent object are also described.

The present invention relates to a new transparent object, comprising a transparent, electrically insulating substrate with a large-area, structured, electrically conducting, transparent coating, comprising at least one locally limited, structured, electrically heatable, transparent area.

Moreover, the present invention relates to a new method for the manufacture of a transparent object, comprising a transparent substrate with a large-area, structured, electrically conducting, transparent coating, comprising at least one locally limited, structured, electrically heatable, transparent area.

And, not least, the present invention relates to the new use of the new transparent object, comprising a transparent, electrically insulating substrate with a large-area, structured, electrically conducting, transparent coating, comprising at least one locally limited, structured, electrically heatable, transparent area, as well as the transparent object manufactured using the new method, comprising a transparent substrate with a large-area, structured, electrically conducting, transparent coating, comprising at least one locally limited, structured, electrically heatable, transparent area.

Laminated safety glass panes, in particular windshields, for motor vehicles that include electrically conducting, transparent layers, and methods for their manufacture are known, for example, from the patent applications and printed patents U.S. Pat. No. 4,010,304, U.S. Pat. No. 4,385,226, U.S. Pat. No. 4,565,719, U.S. Pat. No. 4,655,811, U.S. Pat. No. 4,725,710, U.S. Pat. No. 4,985,312, U.S. Pat. No. 5,111,329, U.S. Pat. No. 5,324,374, EP 0 638 528 A1, EP 0 718 250 A2, DE 697 31 268 T2, WO 00/72635 A1, and U.S. Pat. No. 7,223,940 B2. The electrically conducting, transparent layers may be used for the all-over heating of the laminated safety glass panes or as layers reflecting or absorbing IR-radiation.

Generally, for the all-over heating of laminated safety glass panes for motor vehicles, a voltage of 42 V is required. However, the on-board voltage in the vast majority of motor vehicle models is only 12 to 14 V, such that additional measures, such as the installation of additional electric and electronic components, must be taken to ensure heatability. However, this entails an undesired additional outlay in the manufacture of motor vehicles and, consequently, higher costs. Frequently, it is also the case that no more space for additional components is available in the vehicle body.

Modem windshields for motor vehicles frequently have so-called camera or sensor fields, through which a camera or a sensor “looks through” the windshield. These fields must always be kept free of fogging from water or ice such that the cameras and sensors can fulfill their function. To keep the fields fog free, strip conductors can be incorporated for electrical heating. These strip conductors can, to be sure, be operated with an on-board voltage of 12 to 14 V; however, they may cause undesired shadows.

From patent application WO 00/72635 A1, a windshield electrically heatable all-over is known that has a window that is free of electrically conducting coating. This window is used for data transmission through the windshield. However, this window is not heatable and, consequently, is difficult or impossible to keep fog free.

The object of the present invention is to eliminate the disadvantages of the prior art and to make available new transparent objects, in particular new laminated safety glass panes, especially new windshields that are coated with a transparent coating made of an electrically conducting material, wherein there is at least one locally limited, electrically heatable transparent area, in particular a camera or sensor field. This transparent area should be heatable with a relatively low voltage, in particular a voltage of 12 to 14 V, and should cause no undesired shadows. Moreover, no additional measures, such as installation of additional electrical and electronic components, should be necessary. The electrically heatable, transparent areas should also, in winter operation or cold operation, be capable of being cleared quickly of fogging from moisture and ice and being reliably kept fog free.

Moreover, the object of the present invention is to make available a new method for the manufacture of transparent objects, in particular laminated safety glass panes, especially windshields, which [method] no longer has the disadvantages of the prior art, but rather, in a simple and quite readily reproducible manner, delivers transparent objects in large quantities, that have a transparent coating made of an electrically conducting material, wherein there is, in the coating, at least one transparent area electrically heatable with relatively low voltage, in particular a camera or sensor field. The transparent, electrically heatable area manufactured using the new method should be fully functional even without additional electric and electronic components. The electrically heatable, transparent areas should also, even in winter operation or cold operation, be quickly freed of fogging from moisture and ice and be reliably kept fog free and no longer cause shadows.

And, not least, the object of the present invention is to find a new use for the new transparent objects and the transparent objects manufactured using the new method in means of transportation for land, air, and water traffic as well as in the construction, furniture, and equipment sector, whereas it is, in particular, important in the new application that the relevant transparent objects can also, in locally limited, transparent areas, be freed from fogging from moisture and ice and be reliably kept fog free and no longer cause shadows.

Accordingly, the new transparent object has been discovered, which comprises
at least one transparent, electrically insulating substrate (1),
a structured, transparent coating (2), that
   comprises or is made of at least one electrically conducting material (2.1),
   covers the transparent substrates (1) over a large area,
   has a structure, that is formed from electrically insulating areas (2.2) free of electrically conducting material (2.1), and
   at least one locally limited, structured, electrically heatable, transparent area (2.3), and
   at least one electrically conducting, transparent area (2.4)
      as well as
electrical contacts (3) for applying an electrical voltage to the coating (2), wherein
the coating (2) is structured such that and the electrical contacts (3) are connected such that upon application of a voltage, a current flows at least through the area (2.3).

In the following, the new transparent object that comprises at least one substrates (1), one coating (2), and electrical contacts (3) is referred to as the “object according to the invention”.

Moreover, the new method for the manufacture of a transparent object has been discovered, wherein
(I) an electrically conducting material (2.1) is applied over a large area on a transparent, electrically insulating substrates (1), such that a transparent, electrically conducting coating (2) that comprises or is made of the material (2.1) results,
(II) the coating (2) is structured by removing it in places such that electrically insulating areas (2.2) that are free of electrically conducting material (2.1) result, and
(III) the structured coating (2) is connected to electrical contacts (3),
   wherein the structuring (II) is carried out such that
the structured coating (2) has at least one locally limited, structured, electrically heatable, transparent area (2.3) and at least one electrically conducting, transparent area (2.4) and
upon application of an electrical voltage, a current flows at least through the area (2.3).

In the following, the new method for the manufacture of a transparent object is referred to as the “method according to the invention”.

And, not least, the new use of the object according to the invention and the transparent object manufactured using the new method in means of transportation for land, air, and water traffic as well as in the construction, furniture, and equipment sector, has been found, which is referred to in the following as the “use according to the invention”.

With regard to the prior art, it was surprising and not predictable for the person skilled in the art that the object of the invention could be accomplished using the object according to the invention, the method according to the invention, and the use according to the invention.

In particular, it was surprising that the object according to the invention no longer had the disadvantages of the prior art, but rather that the at least one locally limited, electrically heatable, transparent area, in particular a camera or sensor field, of the structured, transparent coating was heatable with a relatively low voltage, in particular a voltage of 12 to 14 V, and caused no undesired shadows. Moreover, no additional measures, such as installation of additional electrical and electronic components, were necessary. The electrically heatable, transparent area could also quickly be freed of fogging from moisture and ice, in winter operation or in cold operation, and could be reliably kept fog free.

Moreover, it was surprising that the method according to the invention also no longer had the disadvantages of the prior art, but rather delivered transparent objects in large quantities in a simple and quite readily reproducible manner that had a structured, transparent coating, wherein there was in the coating at least one transparent area electrically heatable with relatively low voltage, in particular a camera field and the sensor field, without undesired shadows. [Translator note: “and the” may be a typographical error; “a camera and/or sensor field” seems more likely.] The transparent, electrically heatable areas manufactured using the new method was also fully functional without additional electrical and electronic components. The electrically heatable, transparent areas could also, in winter operation or cold operation, be quickly freed of fogging from moisture and ice and reliably kept fog free.

And, not least, it was surprising that the objects according to the invention and transparent objects manufactured using the method according to the invention in the context of the use according to the invention were eminently suited for use in means of transportation for land, air, and water traffic as well as in the construction, furniture, and equipment sector. The objects according to the invention and transparent objects manufactured according to the method according to the invention could also, in winter operation or cold operation, be quickly freed, in locally limited, electrically heatable, transparent areas free of shadows, of fogging from moisture and ice and reliably kept fog free.

The objects according to the invention are transparent. This means that they, at least in individual areas, but, preferably, overall, are permeable to electromagnetic radiation, preferably electromagnetic radiation with a wavelength of 300 to 1,300 nm, but, in particular, to visible light. “Permeable” means that the transmission, in particular for visible light, is >50%, preferably >75%, and, in particular, >80%.

The objects according to the invention can have different three-dimensional shapes. Thus, they can be planar or slightly or greatly curved or bent in one or more directions or have the shape of regular or irregular three-dimensional bodies, such as spheres, cylinders, cones, pyramids with triangular or rectangular bases, double pyramids, cubes, icosahedrons, etc., in particular, they are planar or slightly or greatly curved or bent in one or more spatial directions.

The size of the objects according to the invention can vary broadly and is based on the respective purpose in the context of use according to the invention. Thus, the objects according to the invention can have a dimension of a few centimeters to multiple meters. In particular, the objects planar or slightly or greatly curved or bent in one or a plurality of spatial directions may have a surface area on the order of 100 cm² to 25 m², preferably >1 m². The surface area can, in the case of these large-area objects according to the invention have the measurement Gen 5 (1.1 m×1.3 m=1.43 m²) and Gen 8.5 (2.2 m×2.6 m=5.72 m²), as they are used in the display industry, or PLF (3.21 m×6.0 m=19.26 m²), which is the “yardstick” of the glass industry. However, the objects according to the invention can also have surface areas like windshields, side windows, and rear windows or large-area panes, as used in the construction sector, commonly have.

The objects according to the invention can have perforations. These can be used to accommodate devices for mounting, for connection to other objects, and/or the passage of conductors, in particular, electrical conductors.

The object according to the invention comprises at least one transparent, electrically insulating substrate. Preferably, the substrate has high transmission for electromagnetic radiation of a wavelength of 300 to 1,300 nm, in particular, however, for visible light, preferably transmission >50%, more preferably >75%, even more preferably >85%, and, in particular, >95%.

Accordingly, all transparent, electrically insulating substrates that have such transmission and are thermally and chemically stable as well as dimensionally stable under the conditions of the manufacture and use of the objects according to the invention are fundamentally suitable.

The transparent, electrically insulating substrates can have any three-dimensional shape of the objects that is prescribed for the objects according to the invention that include them. Preferably, the three-dimensional shape has no shadow zones such that they can be uniformly coated from the gas phase in particular. Preferably, the substrates are planar or slightly or greatly curved in one or a plurality of directions. In particular, planar substrates are used.

The transparent, electrically insulating substrates can be colorless or colored.

Examples of suitable materials for the manufacture of transparent, electrically insulating substrates are glass and clear plastics, preferably rigid clear plastics, in particular, polystyrene, polyamide, polyester, polyvinyl chloride, polycarbonate, or polymethyl methacrylate.

Preferably, transparent, electrically insulating substrates made of glass are used. Basically, all common and known glasses, as are described, for example, in Römpp-Online 2008 under the keywords “Glas [glass]”, “Hartglas [toughened glass]” or “Sicherheitsglas [safety glass]”, come into consideration as substrate material. Examples of well-suited glasses are plate glass, toughened glass, prestressed glass, single-sheet safety glass, apparatus glass, laboratory glass, crystal glass, and optical glass, in particular plate glass and toughened glass.

Examples of suitable glasses are known from the German translation of the European patent EP 0 847 965 B1 with file number DE 697 31 2 168 T2, page 8, par. [0053].

The thickness of the transparent, electrically insulating substrates can vary broadly and, thus, be eminently adapted to the requirements of the individual case. Preferably, glasses with the standard glass thicknesses of 2, 3, 4, 5, 6, 8, 10, 12, 15, 19, and 24 mm are used.

The size of the transparent, electrically insulating substrates can vary broadly and is based on the size of the objects according to the invention that contain them. Accordingly, the above-described sizes are preferably used.

The transparent, electrically insulating substrates are coated with a structured, transparent coating.

Here as well, “transparent” means that the structured, transparent coatings are permeable to electromagnetic radiation, preferably electromagnetic radiation with a wavelength of 300 to 1,300 nm, but, in particular, to visible light. “Permeable” means that the transmission, in particular for visible light, is >50%, preferably >75%, and, in particular >80%. Particularly preferred are structured, transparent coatings that are not permeable to IR radiation, i.e., that they reflect or absorb IR radiation.

“Structured” means that the transparent coating is subdivided into at least two, in particular at least three, areas separated from each other.

The structured, transparent coating comprises or is made of at least one electrically conducting material.

Accordingly, the structured, transparent coating can consist of one layer of an electrically conducting material or of at least two layers of two different electrically conducting materials.

Moreover, the structured, transparent coating can be constructed from at least one layer of an electrically conducting material and at least one layer of a transparent, dielectric material. For example, the structured, transparent coating can consist of a first layer of a transparent, dielectric material, a layer of an electrically conducting material, and a second layer of the same or a different transparent, dielectric material that lie one above the other in the order indicated. It is, however, also possible that the structured, transparent coating consist of at least three transparent, dielectric layers and at least two electrically conducting layers that lie alternatingly one above the other, with at least one transparent, dielectric layer located between the electrically conducting layers.

Examples of suitable electrically conducting materials are metals with high electrical conductivity, such as silver, copper, gold, aluminum, or molybdenum, in particular silver or silver alloyed with palladium, as well as transparent, electrically conducting oxides (transparent conductive oxides, TCO), as they are, for example, described in the American patent application US 2007/029186 A1 on page 3, par. [0026], and page 4, par. [0034].

Preferably, the TCOs are indium tin oxide (ITO), fluorine-doped tin oxide (fluor tin oxide, FTO), aluminum zinc oxide doped with aluminium as well as, possibly, additionally with boron and/or with silver (aluminium zinc oxide, AZO), tin zinc oxide or tin oxide doped with antimony (antimony tin oxide, ATO). Preferably, the TCOs have a specific resistance ρ of 1.0 to 5.0×10⁻³ Ω×m. Preferably, they have a sheet resistance R_{□}of 0.5 Ω/□ to 15 Ω/□.

The thicknesses of the structured, transparent coating can vary broadly and, thus, be eminently adapted to the requirements of the individual case. It is essential that the thickness of the structured, transparent coating not be so high that it becomes nonpermeable to electromagnetic radiation, preferably electromagnetic radiation of a wavelength of 300 to 1,300 nm and, in particular, to visible light.

Preferably, the thickness is from 20 nm to 100 μm.

If the structured, transparent coating is made of a metal, its thickness is preferably 50 to 500 nm, more preferably 75 to 400 nm, and in particular 100 to 300 nm

If the structured, transparent coating is made of a TCO, its thickness is preferably 100 nm to 1.5 μm, more preferably 150 nm to 1 μm, and in particular 200 nm to 500 nm.

If the structured, transparent coating is made of at least one transparent, dielectric layer and at least one layer of a metal, its thickness is preferably 20 to 100 μm, more preferably 25 to 90 μm, and in particular 30 to 80 μm.

Examples of transparent coatings that are suitable for the manufacture of the structured, transparent coatings used according to the invention, as well as methods for their manufacture are known from the patent applications and published patents
US 4,010,304, col. 1, line 67, to col. 5, line 35,
U.S. Pat. No. 4,565,719, col. 2, line 3, to col. 18, line 51,
U.S. Pat. No. 4,655,811, col. 3, line 56, to col. 13, line 63,
U.S. Pat. No. 4,985,312, col. 1, line 64, to col. 7, line 25,
U.S. Pat. No. 5,111,329, col. 3, line 32, to col. 12,
U.S. Pat. No. 5,324,374, col. 2, line 38, to col. 6, line 37,
EP 0 638 528 A1, page 2, line 19, to page 10, line 57,
EP 0 718 250 A2, page 2, line 42, des page 13, line 44,
DE 697 31 268 T2, page 3, par. [0011], to page 7, par. [0051], page 8, par. [0060], to page 13, par. [0091],
WO 00/72635 A1, page 3, line 16 to 35, and
U.S. Pat. No. 7,223,940 B2, col. 5, line 8, to col. 6, line 38.

Moreover, transparent plastic films, preferably on the basis of polyamide, polyurethane, polyvinyl chloride, polycarbonate, and polyvinyl butyral, in particular polyurethane, that are coated with at least one of the above-described electrically conducting materials come into consideration.

The structured, transparent coating covers the transparent, insulating substrates over a large area. Preferably, at least 50%, more preferably at least 70%, particularly preferably at least 80% and in particular at least 90% of a surface of the transparent, insulating substrate is covered by the structured, transparent coating. Thus, the structured, transparent coating can even completely cover the transparent, insulating substrate.

In particular, in the case of the above-described planar or curved or bent substrates, the structured, transparent coatings can cover the substrates such that they are surrounded by an electrically insulating area that is free of electrically conducting material. Preferably, this electrically insulating area is located in the edge areas of the electrically insulating, transparent substrates.

The width of the electrically insulating areas can vary broadly and, consequently, be eminently adapted to the requirements of the individual case. Preferably, the width is from 0.5 to 10 cm, more preferably 0.5 to 7 cm and in particular 0.5 to 5 cm. The electrically insulating area can be covered by a decorative coating.

The structured, transparent coating has a structure that is formed from electrically insulating areas that are free of electrically conducting material. The structure comprises at least one, in particular one, locally limited, structured, electrically heatable, transparent area and at least one electrically conducting, transparent area.

“Locally limited” means that the relevant structured, electrically heatable, transparent area has an area that is smaller than the area of the electrically conducting transparent area.

“Structured” means that the locally limited, electrically heatable, transparent area has a structure that is formed from electrically insulating areas.

“Electrically heatable” means that the locally limited, structured, transparent area has electrical resistance high enough that upon application of an electrical voltage, preferably of the onboard voltage commonly used in motor vehicles, in particular of a voltage of 12 to 14 V, the area is heated.

The structure of the locally limited, electrically heatable, structured, transparent area is configured in individual case such that the electrical resistance is not high enough that the area is damaged by overheating and/or the danger of burning in the event of touching the area with bare skin exists. Preferably, the structure and the electrical resistance are designed such that the area is heated to 30 to 70° C. upon application of a voltage.

The locally limited, electrically heatable, structured, transparent areas can have different structures from case to case such that they can be adapted to the requirements of the individual case.

Preferably, the structures have the shape of a meandering strip conductor.

The meandering strip conductors can have different dimensions. The dimensions are based primarily on the respective electrically conducting material used and its conductivity, its specific electrical resistance, its sheet resistance, and the temperature to which the locally limited, electrically heatable, structured, transparent areas are to be heated. Consequently, the person skilled in the art can specify the dimensions using his knowledge of the art, possibly with the assistance of a few orienting experiments in the individual case.

Preferably, the meandering strip conductors have a width of 0.5 mm to 10 cm. Preferably, their length is 10 cm to 6 m.

The structured, transparent coating is connected to electrical contacts. It is structured overall such that upon application of a voltage to the electrical contacts, a current flows at least through the locally limited, electrically heatable, structured, transparent area.

In a first embodiment of the object according to the invention, the locally limited, electrically heatable, structured, transparent area is electrically isolated from the electrically conducting, transparent area. In this first embodiment, the electrically conducting, transparent area per se does not have to be further structured.

For the first embodiment, it is essential that the locally limited, electrically heatable, structured, transparent area be connected to electrical contacts, such that upon application of a voltage, a current flows through the above-described conductor strip. This can be guaranteed in that the poles of the contacts are separated from each other by an electrically insulating area such that the current has to take the roundabout route via the conductor strip.

In a second embodiment of the object according to the invention, the locally limited, electrically heatable, structured, transparent area is in electrical contact with the electrically conducting, transparent area, with the electrical contacts preferably connected outside the locally limited, electrically heatable, structured, transparent area.

For the second embodiment, it is essential that the electrically conducting, transparent area per each existing, locally limited, electrically heatable, structured, transparent area consist of two subareas, of which one subarea is in contact with the electrical input of the locally limited area and the other subarea is in contact with the electrical output of the locally limited area. This guarantees that upon application of an electrical voltage, a current flows through the locally limited area.

The electrical contacts can be common and known direct contacts or inductive contacts that include a contact bridge and a coil.

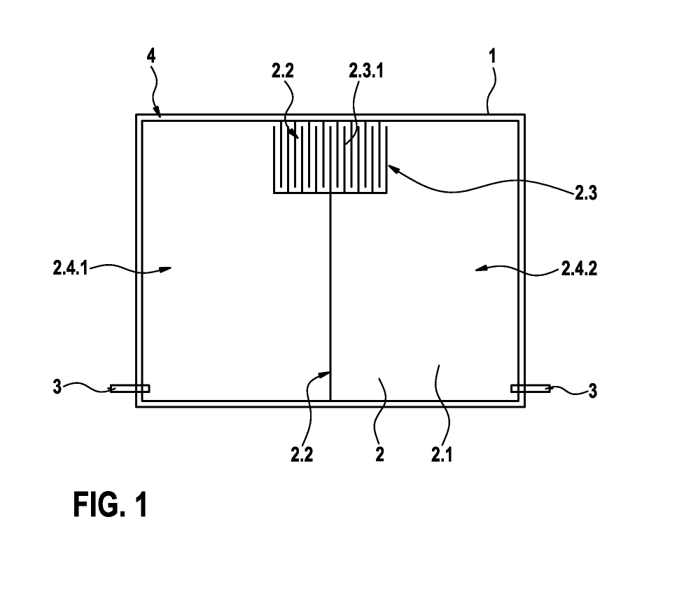

Examples of suitable direct electrical contacts, with which a proper transition from the very thin structured, transparent coating to the common dimensions of cables and plugs can be accomplished, are known from the American patent U.S. Pat. No. 7,223,940 B2, col. 1, line 55, to col. 2, line 43, and col. 6, line 48, through col. 9, line 59, in conjunction with FIG. 1 through 9.

In the case of inductive contacts, the coil can be made of electrically insulated, thin wires. However, preferably, the coil is integrated into the structured, transparent coating. This means that it is a component of the structure of the transparent coating and is formed by a spiral-shaped, electrically insulating area that is free of electrically conducting material. The structured, transparent coating in the form of a through-going strip conductor is located between the windings of this spiral-shaped, electrically insulating area.

In the case of the first embodiment, the coil is located within the locally limited, structured, electrically heatable, transparent area and integrated therein such that upon application of a voltage, the current must take the roundabout route via the above-described conductor strip.

In the case of the second embodiment, the coil is located within a subarea of the electrically conducting, transparent area that is in electrical contact with the electrical output or input of the above-described strip conductor of the locally limited, structured, electrically heatable, transparent area.

The electrical contact bridge is located outside the structured, transparent coating above the coil and projects in the case of the first embodiment into the area above the electrical output area of the strip conductor. In the case of the second embodiment, it projects into the area above the other subarea of the electrically conducting, transparent area.

The above-described structure of the structured, transparent coating is formed by electrically insulating areas that are free of electrically conducting material. The dimensions of the electrically insulating areas can vary broadly and, consequently, can be eminently adapted to the requirements of the individual case. Preferably, they have a width of 100 nm to 5 mm, more preferably 150 nm to 5 mm, particularly preferably 200 nm to 5 mm, and in particular 250 nm to 5 mm

The depth of the electrically insulating areas can also vary broadly and, consequently, can be eminently adapted to the requirements of the individual case. It is essential that the areas no longer contain any electrically conducting material. Preferably, the electrically insulating areas have a depth that extends from the surface of the structured, transparent coating to the surface of the electrically insulating, transparent substrate.

The cross-sectional profile of the electrically insulating areas can also vary broadly and can be adapted to the requirements of the individual case. It is essential that the distance between the walls of the areas not be small enough that the danger of short-circuits exists. Preferably, the electrically insulating areas have a rectangular cross-sectional profile.

If the electrically insulating, transparent substrate is made of a glass, at least one more layer can be located between its surface and the structured, transparent coating. Preferably, the at least one more layer is selected from the group of transparent barrier layers and transparent, adhesion-promoting layers.

Suitable transparent barrier layers to prevent the diffusion of ions, in particular of alkali metal ions, are preferably made of dielectric materials, in particular of nitrides, oxides, and oxynitrides of silicon and/or aluminum. Preferably, they have a thickness of 30 to 300 nm.

Suitable transparent, adhesion-promoting layers likewise are made of dielectric materials, in particular of mixed oxides of zinc and tin. Preferably, they have a thickness of 3 to 100 nm.

If both a transparent barrier layer and a transparent adhesion-promoting layer are present, the transparent barrier layer is connected directly with the surface of the electrically insulating, transparent substrate.

The object according to the invention can be manufactured in extremely different ways.

For example, a mask that corresponds to the desired structure of the electrically insulating areas that are free of electrically conducting material can be applied on the electrically insulating, transparent substrate. Then, at least one electrically conducting material can be deposited from the gas phase onto the substrate, whereby the methods described in the following can be used. The above-described structured, transparent coating is created directly. Then, the mask is removed, and the structured, transparent coating is, as described in the following, connected to electrical contacts such that upon application of a voltage, a current flows at least through the locally limited, structured, electrically heatable transparent area.

However, according to the invention, it is advantageous to manufacture the object according to the invention using the method according to the invention. On the other hand, methods according to the invention can also be used for the manufacture of transparent objects other than the objects according to the invention. But the method according to the invention develops its particular advantages in particular in the manufacturer of the object according to the invention.

Before the performance of the first step of the method, the electrically insulating, transparent substrate can be treated thermally, cleaned, in particular degreased, and/or polished. Then, at least one of the above-described barrier layers and/or adhesion-promoting layers can be applied, whereby the methods for depositing thin layers from the gas phase described in the following can be used.

In the first step of the method, at least one electrically conducting material is applied over a large area on the transparent, electrically insulating substrate or on the surface of a layer located thereon such that a transparent, electrically conducting coating that comprises or is made of the electrically conducting material results.

For this, known methods and devices can be used, such as deposition from the gas phase, application from the liquid phase, or laminating of plastic films that are coated with electrically conductive materials.

Preferably, the transparent, electrically conducting coating is deposited from the gas phase, whereby common and known methods such as chemical glass phase deposition (CVD [chemical vapor deposition]) or physical glass phase deposition (PVD [physical vapor deposition]) as well as the corresponding devices suitable for this can be used. Examples of CVD methods are spray pyrolysis, chemical vapor deposition, and sol-gel deposition. Examples of PVD methods are electron beam vapor deposition and vacuum sputtering.

Preferably, sputtering methods are used.

Sputtering is a common and known method for the manufacture of thin layers of materials that cannot be readily vaporized. In it, the surface of a solid body of suitable composition, the so-called target, is atomized by bombardment with high-energy ions from low-pressure plasmas, such as oxygen ions (O⁺) and/or argon ions (Ar⁺), or neutral particles, after which the atomized materials are deposited on substrates in the form of thin layers (cf. Römpp Online, 2008, “Sputtering”). Preferably, high-frequency sputtering, known as HF-sputtering, or magnetic field assisted sputtering, known as magnetron sputtering (MSVD), is used.

Suitable sputtering methods are described, for example, in the American patents U.S. Pat. No. 7,223,940 B2, col. 6, lines 25 through 38, and U.S. Pat. No. 4,985,312, col. 4, page 18, through col. 7, line 10, or in the German translation of the European patent EP 0 847 965 B1 with the file number DE 697 31 268 T2, page 8, par. [0060], and page 9, par. [0070], through page 10, par. [0072].

In the second step of the method according to the invention, the transparent, electrically conducting coating is structured by removing it in places such that electrically insulating areas that are free of electrically conducting material result.

The electrically conducting material can be removed mechanically, thermally, and/or by irradiation with electromagnetic radiation.

One advantageous method of mechanical removal that works very precisely and can deliver particularly fine electrically insulating areas is ultrasound hammering.

One advantageous method for removal through thermal action and/or by irradiation with electromagnetic radiation that likewise works very precisely and can deliver particularly fine electrically insulating areas is laser beam irradiation with a laser beam, as is described, for example, in the European patent applications EP 0 827 212 A2 and EP 1 104 030 A2.

If the structured, transparent coating is to be surrounded by an electrically insulating area that is free of electrically conducting material, the electrically conducting material in this area is preferably abraded by mechanical methods such as grinding.

Then, this electrically insulating area can be provided with a decorative coating to optically conceal the transition from an electrically insulating area to a structured, transparent coating.

Then, the structured, transparent coating can be treated with a liquid or gaseous, in particular liquid, etchant to remove residues of electrically conducting material possibly still present in the electrically insulating areas.

The liquid etchants are preferably selected from the group consisting of liquid organic compounds, liquid inorganic compounds, solutions of solid, liquid, and gaseous organic and inorganic compounds in organic solvents, and solutions of solid, liquid, and gaseous organic and inorganic compounds in water. Solutions of organic and inorganic acids and bases in water are preferably used. Volatile organic and inorganic acids, in particular inorganic acids are preferably used.

Preferably, the structured, transparent coatings are washed with a cleaning agent such as highly purified water after etching.

Then, the electrically insulating, transparent substrates that have a structured, transparent coating can be shaped, in particular bent or curved, at relatively high temperatures.

The height of the temperatures is determined by the materials, from which the respective insulating, transparent substrates and/or the structured, transparent coatings are made. If they contain or are made of plastic, the temperature must not be set high enough that the material melts or and/or is thermally damaged. Preferably, in these cases, the temperature is above the glass transition temperature and below 200° C. In the case of substrates made of glass, the temperature is between 500 and 700° C., in particular 550 and 650° C.

After its manufacture, the structured, transparent coating is connected to electrical contacts, preferably to the above-described electrical contacts.

In the method according to the invention, the above-described structuring occurs such that the structured, transparent coating has at least one locally limited, structured, electrically heatable, transparent area and at least one electrically conducting, transparent area, such that upon application of an electrical voltage, a current flows at least through the locally limited, structured, electrically heatable, transparent area.

The transparent objects according to the invention and the transparent objects manufactured using the method according to the invention, in particular the objects according to invention manufactured using the method according to the invention can include additional functional layers and additional electrically insulating, transparent substrates.

Examples of suitable functional layers are coloring layers, layers that increase the structural stability of the objects according to invention, light reflecting layers, and anti-reflection layers.

In particular, layers are used that increase the structural stability of the objects according to the invention. These can be adherent layers, composite films, mechanical energy absorbing films, and self-healing films made of casting resins, such as curable epoxy resins, or thermoplastic synthetics, such as polyvinyl butyral, PVB, poly(ethylene vinyl acetate), EVA, polyethylene terephthalate, PET, polyvinyl chloride, PVC, ionomer resins based on ethylene and/or propylene and alpha, beta-unsaturated carboxylic acids or polyurethane, PU, as they are known, for example, from the German translation of the European patent EP 0 847 965 B1 with the file number DE 697 31 2 168 T2, page 8, par. [0054] and [0055], or the international patent applications WO 2005/042246 A1, WO 2006/034346 A1 and WO 2007/149082 A1.

If necessary, in these layers, the areas that lie directly above the locally limited, structured, electrically heatable, transparent areas can be left open.

Preferably, the additional electrically insulating, transparent substrates are the above-described substrates, in particular substrates made of glass.

Preferably, the additional electrically insulating, transparent substrates are adapted in their area and shape to the objects according to the invention such that they can be connected thereto without problems.

Preferably, the resulting objects according to the invention that include additional layers and/or substrates are structured such that the structured, transparent coating is in each case located in the interior of the objects according to the invention.

In the context of the use according to the invention, the objects according to the invention and the transparent objects manufactured using the method according to the invention, in particular the objects according to the invention manufactured using the method according to the invention are used advantageously in means of transportation for land, air, and water traffic, preferably in motor vehicles, such as automobiles, trucks, and trains, in aircraft and ships as well as in the furniture, equipment, and construction sector, preferably as transparent components.

Particularly preferably, the objects according to the invention are used in the form of single-sheet safety glass panes and laminated safety glass panes as window panes in means of transportation, in particular as windshields for motor vehicles, especially automobiles, as architectonic components in the construction sector, in particular for overhead glazing for roofs, glass walls, facades, window panes, glass doors, balustrades, railing glass, skylights, or glass that can be walked on, as well as components in furniture and equipment, in particular in refrigerators and deep freezer display cases.

Since the single-sheet safety glass panes and composite safety glass panes according to the invention have locally limited, transparent areas electrically heatable with low-voltage that are free of shadows, they are not only eminently suitable as fog-free camera and sensor fields for the passage of data in the form of electromagnetic radiation from “outside to inside”, but also for the passage of data in the form of electromagnetic radiation from “inside to outside”. Thus, for example, a sensor for distance measurement in the interior of a motor vehicle behind a pane is not impaired in its function even in winter. Instead, the view of an object that is located behind a pane, transparent refrigerator door, or transparent display case door according to the invention, such as a clock or a display, remains unclouded, even in winter or in cold operation.

In the following, the object according to the invention is explained by way of example with reference to FIG. 1 through 3. FIG. 1 through 3 are schematic depictions intended to illustrate the principle of the invention. The schematic depictions do not, consequently, need to be true to scale. Consequently, the size relationships depicted do not have to correspond to the size relationships used in the exercise of the invention in practice.

FIG. 1 depicts a first alternative for the second embodiment of the invention.

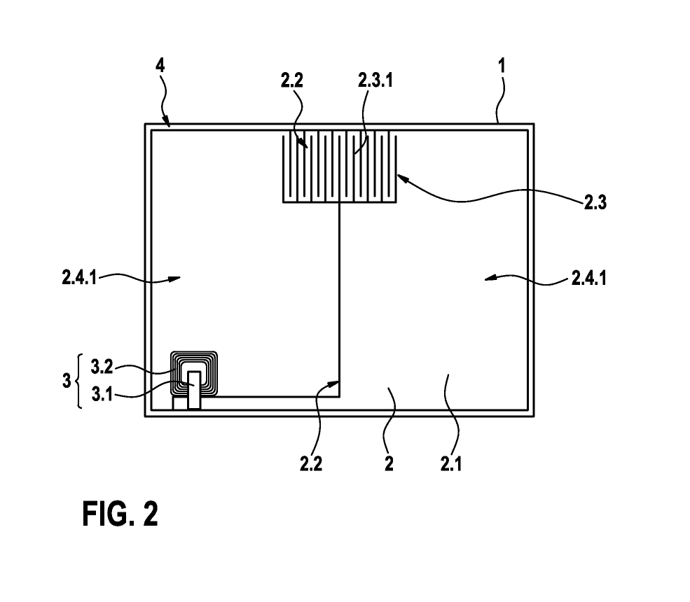

FIG. 2 depicts a second alternative for the second embodiment of the invention.

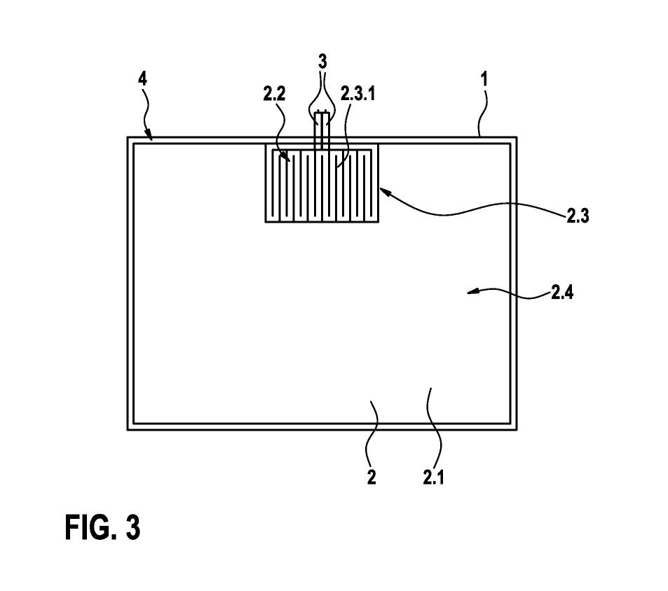

FIG. 3 depicts an alternative for the first embodiment of the invention.

In FIG. 1 through 3, the reference characters have the following meaning:
(1) transparent, electrically insulating substrate,
(2) structured, transparent coating,
(2.1) electrically conducting material,
(2.2) electrically insulating area,
(2.3) locally limited, structured, electrically heatable, transparent area,
(2.3.1) meandering strip conductor,
(2.4) electrically conducting, transparent area,
(2.4.1) electrically conducting, transparent subarea,
(2.4.2) electrically conducting, transparent subarea,
(3) electrical contact,
(3.1) electrical contact bridge,
(3.2) coil, and
(4) electrically insulating area.

In the following, for the sake of brevity, the objects according to the invention of FIG. 1 through 3 are referred to as “objects 1 through 3 according to the invention”.

The substrates (1) of the objects 1 through 3 according to the invention are float glass panes of dimensions, as they are used, for example, for windshields, side windows, and rear windows in automobile construction, in small, medium, or large-area panes in the furniture, equipment, or construction sector. The dimensions can be several square centimeters to several square meters.

The coatings (2) of the objects 1 through 3 according to the invention are in each case a coating, as it is described in the German translation of the European patent EP 0 847 965 B1 with the file number DE 697 31 2 168 T2, Example 1, page 9, par. [0063], through page 11, par. [0080]. This layer comprises two layers made of silver as an electrically conducting material (2.1). The areas (2.2) complementary to the strip conductors (2.3.1), to the area (2.4) as well as to the subareas 2.4.1) and (2.4.2) are inscribed in these layers.

The coatings (2) of the objects 1 through 3 according to the invention are surrounded by an electrically insulating area (4) of a width in the range from 0.5 to 10 cm.

The electrically insulating areas (2.2) of the objects 1 through 3 according to the invention have a depth that corresponds to the thickness of the coatings (2). Their width is in the range from 100 nm to 5 mm

The locally limited, structured, electrically heatable, transparent areas (2.3) of the objects 1 through 3 according to the invention are formed in each case by a meandering strip conductor (2.3.1) of a length in the range from 10 cm to 6 m and a width in the range from 0.5 mm to 10 cm as well as the electrically insulating areas (2.2) complementary thereto.

In the object 3 according to the invention, the area (2.3) is electrically isolated from the electrically conducting, transparent area (2.4). In this embodiment, the object 3 according to the invention 3 comprises only one area (2.4).

In the objects 1 and 2 according to the invention, input and output of the respective areas (2.3) are in electrical contact with a subarea (2.4.1) or (2.4.2), respectively, which are separated from each other by an area (2.2).

In the object 1 according to the invention, one direct electrical contact (3) is connected to the subarea (2.4.1), whereas the other direct electrical contact (3) is connected to the subarea (2.4.2). Upon application of an electrical voltage of 12 to 14 V, a current flows through the strip conductor (2.3.1), such that the area (2.3) is heated to 50° C.

The object (2) according to the invention includes an inductive electrical contact (3) that comprises a coil (3.2) and a contact bridge (3.1). The coil (3.2) is inscribed using a through-passing spiral-shaped area (2.2) in the subarea (2.4.1) of the coating (2). The electrical contact bridge is located without contact above the coating (2) and reaches from the center of the coil (3.2) into the subarea (2.4.1). Upon application of an electrical voltage of 12 to 14 V, a current flows through the strip conductor (2.3.1), such that the area (2.3) is heated to 50° C.

In the object 3 according to the invention, the direct electrical contacts (3) are connected to the area (2.3), such that upon application of an electrical voltage of 12 to 14 V, an electrical current flows through the strip conductor (2.3.1), such that the area (2.3) is heated to 50° C. For this purpose, there is also an area (2.2) (not shown) located between the two electrical contacts (3).

1. A transparent object, comprising:
a) at least one transparent electrically insulating substrate;
b) a structured transparent coating that:
b1) comprises or is made of at least one electrically conducting material (2.1),
b2) covers a large area of the at least one transparent electrically insulating substrate;
b3) has a structure formed from electrically insulating areas free of electrically conducting material;
b4) has at least one localized limited, structured, electrically heatable, transparent area;
b5) has at least one electrically conducting transparent area; and
c) a plurality of electrical contacts for applying an electrical voltage to the structured transparent coating, wherein
the structured transparent coating is structured and the plurality of the electrical contacts are connected such that upon application of the electrical voltage, a current flows at least through the at least one localized, structured, electrically heatable, transparent area.

2. The transparent object according to claim 1, wherein the at least one localized, structured, electrically heatable, transparent area is electrically isolated from the at least one localized, structured, electrically heatable, transparent area and is connected to the plurality of the electrical contacts.

3. The transparent object according to claim 1, wherein the at least one localized, structured, electrically heatable, transparent area is in electrical contact with the at least one electrically conducting transparent area, such that the plurality of the electrical contacts are connected to the structured transparent coating outside the at least one localized, structured, electrically heatable, transparent area.

4. The transparent object according to claim 1, wherein the electrically conducting transparent area further comprises a first subarea in contact with an electrical input of the at least one localized, structured, electrically heatable, transparent area and a second subarea in contact with the electrical output of the at least one localized, structured, electrically heatable, transparent area.

5. The transparent object according to claim 1, wherein the at least one localized, structured, electrically heatable area has a structure of a meandering strip conductor.

6. The transparent object according to claim 5, wherein the meandering strip conductor has a width of 0.5 mm to 10 cm.

7. The transparent object according to claim 5, wherein the meandering strip conductor has a length of 10 cm to 6 m.

8. The transparent object according to claim 1, wherein the structured transparent coating has a uniform layer thickness of 50 nm to 100 μm.

9. The transparent object according to claim 1, wherein the structured transparent coating further comprises at least one layer of the electrically conducting material.

10. The transparent object according to claim 1, wherein the electrically insulating areas have a width of 100 nm to 5 mm.

11. The transparent object according to claim 1, wherein the coating is surrounded by the electrically insulating area free of electrically conducting material.

12. The transparent object according to claim 1, wherein the electrical contacts are direct contacts or inductive contacts.

13. A method of manufacturing a transparent object comprising:
applying at least one electrically conducting material over a large area on a transparent electrically insulating substrate thus coating the transparent electrically insulating substrate with the at least one electrically conducting material;
removing the at least one electrically conducting material from electrically insulating areas to form a structured transparent coating such that the electrically insulating areas are free of electrically conducting material; and
connected connecting the structured transparent coating with electrical contacts such that:
i) the structured transparent coating comprises
at least one localized, structured, electrically heatable, transparent area and at least one electrically conducting transparent area, and
ii) upon application of an electrical voltage, a current flows at least through the localized, structured, electrically heatable, transparent area.

14. The method according to claim 13, wherein the electrically conducting material is removed mechanically, thermally, and/or by irradiation with electromagnetic radiation.

15. A method of using transparent objects according to claim 1, comprising providing the transparent objects in a means of land transportation, a means of air transportation, a means of water traffic transportation, as furniture, equipment, or construction sector.

16. A method of using transparent objects manufactured according to claim 13, comprising providing the transparent objects in a means of land transportation, a means of air transportation, means of water traffic transportation, furniture, equipment, or construction sector.
